(19) United States
(12) Patent Application Publication
(10) Pub. No.: US 2006/0249559 A1
(43) Pub. Date: Nov. 9, 2006

(54) TUBE MILL WITH IN-LINE BRAZE COATING SPRAY PROCESS

(75) Inventor: William E. Panthofer, Jackson, TN (US)

Correspondence Address: HARTMAN & HARTMAN, P.C., 552 EAST 700 NORTH, VALPARAISO, IN, 46383, US

(73) Assignee: MILL MASTERS, INC., Jackson, TN (US)

(21) Appl. No.: 11/423,591

(22) Filed: Jun. 12, 2006

Related U.S. Application Data
(62) Division of application No. 11/160,118, filed on Jun. 9, 2005.
(60) Provisional application No. 60/521,643, filed on Jun. 9, 2004.
(60) Provisional application No. 60/522,287, filed on Sep. 13, 2004.

(51) Int. Cl. A47J 36/02

(52) U.S. Cl. 228/101

(57) ABSTRACT

A process and apparatus for continuously forming and coating a tube with a braze alloy. The apparatus includes a device for continuously delivering tubing material to a device that forms a continuous tube from the tubing material, a device for preheating the tube, a device for depositing the braze alloy on the tube, a device for cooling the tube and the braze alloy layer before the surface of the braze alloy layer oxidizes, and optionally a device for sizing the tube. The deposition device includes an enclosure and at least one thermal spray gun that receives a metallic material from the source, heats the metallic material, and deposits the metallic material through an inert gas to form a layer of the braze alloy on the surface of the tube as the tube continuously travels through the enclosure.

### CROSS REFERENCE TO RELATED APPLICATIONS

This application is a division of U.S. patent application Ser. No. 11/160,118 filed Jun. 9, 2005, which claims the benefit of U.S. Provisional Application Nos. 60/521,643 filed Jun. 9, 2004, and 60/522,287 filed Sep. 13, 2004.

### BACKGROUND OF THE INVENTION

The present invention generally relates to coating processes, and more particularly to coating apparatuses and processes suitable for use in the manufacture of heat exchangers and the components.

The manufacture of heat exchangers requires the joining of fluid passages (typically metal tubes) to heat transfer surfaces such as fins. For example, one type of heat exchanger construction used in the automotive industry comprises a number of parallel tubes that are joined to and between a pair of manifolds, creating a parallel flow arrangement. The ends of the tubes are typically metallurgically joined (brazed, soldered, or welded) to tube ports, generally in the form of holes or slots formed in a wall of each manifold. The tubes thermally communicate with high surface area fins in order to maximize the amount of surface area available for transferring heat between the environment and a fluid flowing through the tubes. The fins are typically in the form of flat panels having apertures through which tubes are inserted, or in the form of sinusoidal centers that are positioned between adjacent pairs of ♭flat” tubes with oblong cross-sections.

Tube-to-fin joints formed by brazing techniques are characterized by strong metallurgical bonds that can be formed at temperatures that do not exceed the softening temperatures of the components being joined. One such brazing process is the CUPROBRAZE® process, which involves depositing a braze paste on the tubes or fins, which are then assembled and heated to a suitable brazing temperature. The paste used in the CUPROBRAZE® process contains binders and a metal braze alloy based on the CuSnNiP system, for example, about 75% copper, about 15% tin, about 5% nickel, and about 5% phosphorus. Equipment for the CUPROBRAZE® process is commercially available from various sources, such as Scholer Spezialmaschinenbau GmbH and Bondmet, Ltd., and can be integrated into a tube mill to provide a process that continuously forms and coats tubing suitable for heat exchanger applications.

Shortcomings of brazing operations that use a braze paste include relatively high material costs, labor requirements, and inconsistent coating thickness. Therefore, alternative processes would be desirable.

### BRIEF SUMMARY OF THE INVENTION

The present invention provides a process and apparatus suitable for continuously forming and directly coating a tube with a braze alloy, without the use of a braze paste. The apparatus includes means for continuously delivering tubing material to a forming means that forms a continuous tube from the tubing material downstream of the delivering means, a source containing a metallic material whose bulk composition is essentially the composition of the braze alloy, means for preheating the tube to a temperature of, for example, at least 65° C., means for depositing the braze alloy on a surface of the tube after the tube is heated by the preheating means, and means for cooling the tube and the braze alloy layer as the tube travels downstream from the depositing means and before the surface of the braze alloy layer oxidizes. The depositing means includes an enclosure, at least one thermal spray gun that receives the metallic material from the source, heats the metallic material, and deposits the metallic material to form a layer of the braze alloy on the surface of the tube as the tube continuously travels through the enclosure, and an inert gas through which the metallic material travels from the thermal spray gun to the surface of the tube.

The process of this invention involves continuously forming a tubing material to form a continuously moving tube, preheating the moving tube to a temperature of at least 65° C., depositing the braze alloy on a surface of the moving tube after the moving tube is preheated, and then cooling the moving tube and the braze alloy layer as the moving tube travels away from the at least one thermal spray gun and before the surface of the braze alloy layer oxidizes. The depositing step involves causing the moving tube to pass through an enclosure and employing at least one thermal spray gun to heat a metallic material whose bulk composition is essentially the composition of the braze alloy, and then deposit the metallic material through an inert gas as the metallic material travels from the thermal spray gun to the surface of the moving tube to form a layer of the braze alloy on the surface of the moving tube as the moving tube passes through the enclosure.

The thermal spray process produces a braze alloy layer that is strong, clean, and dense without damaging, distorting, or causing metallurgical changes within the tube. Compared to prior deposition processes that deposit a braze paste, the apparatus and process of this invention are capable of directly forming on the tube surface a thin, uniform, and dense braze alloy layer immediately after the tube is formed on a tube mill and at typically tube mill speed so that a continuous tube is coated and sized correctly as it leaves the tube mill. In further contrast to processes employing a braze paste, a secondary operation to dry the braze alloy layer is not required, and material costs are significantly reduced since the metallic material and the directly-deposited braze alloy layer do not require any binders.

Other objects and advantages of this invention will be better appreciated from the following detailed description.

### BRIEF DESCRIPTION OF THE DRAWINGS

FIGS. 1 and 2 schematically represent plan and elevation views of a coating apparatus in accordance with a first embodiment of this invention.

FIGS. 3 and 4 schematically represent plan and elevation views of a coating apparatus in accordance with a second embodiment of this invention.

### DETAILED DESCRIPTION OF THE INVENTION

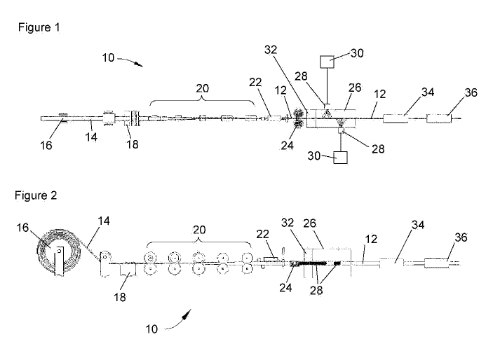

Illustrated in FIGS. 1 and 2 is a coating apparatus 10 in accordance with a first embodiment of the invention. The apparatus 10 performs an in-line spray process that applies a braze alloy coating directly on a continuously moving tube 12, such as a heat exchanger tube. Such tubes, which typically range in width from about 10 mm to about 100 mm wide, are typically manufactured on tube mills at high linear velocities, such as 150 meters per minute. The apparatus 10 incorporates thermal spray equipment into equipment typically required by a tube mill, such that molten braze alloy is directly deposited onto the tube 12 immediately after the tube 12 is formed from suitable metal stock, such as a strip 14. Because the forming and coating processes are continuous, the strip 14 is continuously fed from a large spool 16 in accordance with conventional tube mill processes.

Preferred braze alloys used to form the coating contain copper, tin, nickel, and phosphorus, though it is foreseeable that other coating materials could be used. In practice, it has been determined that the coating must contain at least one weight percent nickel for field corrosion resistance and sufficient phosphorus as a flux during a subsequent brazing operation, for example, in which the tube 12 is brazed to fins to form a heat exchanger. Preferred compositions for the braze alloy depend on the form in which the alloy is provided for deposition, which in turn depends on the thermal spray process used as discussed in greater detail below. In a preferred embodiment, the braze alloy is in wire form and preferably contains, by weight, about 6% to about 7% tin, about 1% to about 2.5% nickel, and about 6% to about 7% phosphorus, with the balance being copper and incidental impurities. If used in powder form, the braze alloy preferably contains, by weight, about 9.0% to about 15.6% tin, about 4.2% to about 5.4% nickel, about 5.3% to about 6.2% phosphorus, about 74.9% to about 79.4% copper, and incidental impurities. In practice, a minimum coating thickness of about 0.0007 inch (about 18 micrometers) is believed necessary to obtain an acceptable tube-to-fin braze. On a coverage basis, braze alloys of this invention must be deposited in excess of 150 grams/m² on the tube 12 to obtain a good braze.

FIGS. 1 and 2 depict the tube 12 as preferably undergoing conventional tube mill operations before deposition of the braze alloy coating. As shown in FIGS. 1 and 2, the strip 14 passes through a strip guide 18 before passing through a series of rolls 20 that deform the strip 14 into a tubular shape, after which the tubular-shaped strip 14 passes through a welding station 22 where the strip 14 is welded to yield the tube 12. The enclosure in which the weld operation is performed can be purged with argon or nitrogen to prevent or at least reduce oxidation of the tube 12. While various cross-sectional shapes are possible, the tube 12 is preferably in the form of a “flat” tube with an oblong cross-section defined by two relatively wide oppositely-disposed flat surfaces. FIGS. 1 and 2 show the tube 12 passing between an opposed pair of abrasive wire brush wheels 24 that roughen the flat surfaces of the tube 12 for the purpose of promoting adhesion of the braze alloy coating, which is deposited on the flat surfaces that are later brazed to the fins. As alternatives to the brush wheels 24, the tube surfaces can be roughened with a bead blast, or the tube strip 14 could be supplied with a pre-brushed finish. Following welding and surface roughening, the tube 12 must be dry and free of oils and coolant prior to the spray coating operation.

The thermal spray process is carried out in an enclosure 26 that preferably contains an inert gas such as argon to avoid oxidation of the braze alloy while it is molten during and immediately after deposition. Thermal guns 28 are mounted in the enclosure 26, which is preferably equipped with a preheater 32 capable of heating the tube 12 to at least 150° F. (about 65° C.), which according to the invention is believed necessary to promote adhesion of the braze alloy coating at the high speed at which the tube 12 is traveling during the coating process. The enclosure 26, along with any sound abatement and dust collection system, is preferably designed to maintain a neutral to slightly positive pressure environment within the enclosure 26 to maintain the inert atmosphere.

As known in the art, thermal spray processes involve spraying molten or at least heat-softened material onto a substrate surface to form a coating. Two thermal spray processes are generally encompassed by this invention: plasma spray (also known as plasma arc spray and nontransferred arc spray), and arc spray (also known as wire arc spray). With either coating process, it has been determined that preferred CuSnNiP coatings deposited on the tube 12 are prone to oxidation to the extent that they will not braze, such that the coatings should be deposited through a shroud of inert or at least nonreactive gas. The brazeability of the deposited coating can be judged based on its color. A coating having a gray color is sufficiently oxide-free to permit subsequent brazing. While exhibiting good adhesion, a gold-colored coating is oxidized to the extent that it will not braze successfully.

In plasma spray processes, material in powder form (preferably with the powder composition noted above) is injected into a very high temperature plasma generated by a gas (typically argon, nitrogen, hydrogen, or helium) forced through a high voltage discharge between two electrodes, causing the gas to rapidly heat and accelerate to a high velocity that carries the molten powder to the substrate being coated. The hot material impacts the substrate surface and rapidly cools to form the coating. This process is sometimes referred to as a cold process (relative to the substrate material) since the substrate temperature can be kept low during processing, thus avoiding damage, metallurgical changes, and distortion to the substrate material. The powder is fed from a suitable source 30 into the plasma, where it is rapidly heated and accelerated. To prevent oxidation of the braze alloy, the plasma spray process of this invention is preferably conducted in an inert atmosphere (e.g., argon) within the enclosure 26, and as such can be referred to as vacuum plasma spraying (VPS) or low pressure plasma spraying (LPPS).

In conventional wire arc spray processes, two wires of the desired coating material are typically used as electrodes across which a high voltage discharge is maintained to melt the wires, and air is forced between the two wires to atomize and propel the molten wire material at the substrate being coated. Contrary to conventional practice, the wire arc spray process of this invention preferably employs an inert or nonoxidizing gas such as nitrogen or argon as the carrier gas to avoid oxidation of the braze alloy, as discussed above. To deposit a braze alloy coating with the preferred wire composition noted above, the bulk composition of the wires should be essentially the same as the desired braze alloy coating. For this purpose, the entire wire may have the composition of the desired coating, or the wire can be formed to have a hollow core formed of copper or tin and filled with a powder whose composition is the balance of the desired coating.

Thermal spray guns are typically only about 50% to about 80% efficient, necessitating that spray rates must exceed 150 grams/m² to deposit enough coating on the tube 12 to obtain the desired 150 grams/m² coverage. If the coating is deposited by wire arc spraying, the desired coating coverage is also believed to require the use of wires with a minimum diameter of 0.080 inch (about 2 mm) in view of typical wire arc spray rates being about 35 to 80 pounds (about 16 to 36 kg) per hour, depending on the wire diameter, amperage of the power supply, and capability of the wire feeder. Furthermore, multiple arc spray guns 28 will typically be needed in view of the typical high line speeds of production tube mills. The guns 28 can be arranged in a straight line, W, or V-shaped pattern along the horizontal direction of travel of the tube 12 through the enclosure 26. The interior walls of the enclosure 26 are preferably coated with a non-stick surface treatment or are otherwise formed of a material that inhibits adhesion of the over-spray from the spray guns 28.

The wire arc spray process is believed to be preferred for use with the invention. For example, plasma spray processes use nitrogen as the plasma gas but argon is required to start the actual arc, necessitating a controlled argon purge to start the plasma gun then switching to nitrogen. Also, the wire arc spray process can immediately start spraying the braze alloy, whereas plasma spray processes require a minute or two to warm up before spraying can commence. Finally, the desired coverage for the tube 12 can be difficult to achieve with plasma spray powders, necessitating the use of relatively large particles in order to enable accurate metering and control of the powder feed rate.

Finally, FIGS. 1 and 2 represent the apparatus 10 as preferably including a quenching station 34 and sizing station 36 downstream from the thermal spray enclosure 26, where the tube 12 is cooled and then undergoes a final sizing operation, as known in the art. The cooling step is preferably carried out in a manner that cools the braze alloy coating on the tube 12 before the surface of the coating oxidizes. For this purpose, the quenching station 34 may be located immediately adjacent the enclosure 26 or the tube 12 can be continuously enclosed and enveloped by an inert gas up to and through the quenching station 34.

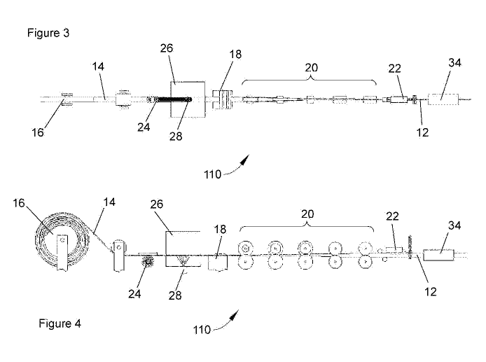

FIGS. 3 and 4 depict a second embodiment of the invention that differs from the embodiment of FIGS. 1 and 2 primarily by the order of operations, the use of a single thermal spray gun 28, and the omission of the preheater 32 and sizing station 36. As evidenced by FIGS. 3 and 4, it is possible to perform the thermal spraying operation on the strip 14 before forming and welding the tube 12, though such an approach is not believed to be preferred for most applications. Notably, by moving the brush wheel 24 and spray gun 28 to face the opposite side of the strip 14, the apparatus 110 of FIGS. 3 and 4 can be adapted to deposit a braze alloy layer on the surface of the strip 14 that after forming defines the interior surface of the tube 12, such that internal fins used in charge air coolers and intercoolers can be later brazed within the tube 12. For such an application, spray guns 28 could be positioned on opposite sides of the strip 14 so that a layer of the braze alloy is provided on both the interior and exterior surfaces of the tube 12.

While the invention has been described in terms of particular embodiments, it is apparent that other forms could be adopted by one skilled in the art. Therefore, the scope of the invention is to be limited only by the following claims.

1. An apparatus for continuously forming and coating a tube with a braze alloy, the apparatus comprising;
means for continuously delivering tubing material;
means for forming a continuous tube from the tubing material downstream of the delivering means;
a source containing a metallic material whose bulk composition is essentially the composition of the braze alloy;
means for preheating the tube to a temperature of at least 65° C.;
means for depositing the braze alloy on a surface of the tube after the tube is heated by the preheating means, the depositing means comprising an enclosure, at least one thermal spray gun that receives the metallic material from the source, heats the metallic material, and deposits the metallic material to form a layer of the braze alloy on the surface of the tube as the tube continuously travels through the enclosure, and an inert gas through which the metallic material travels from the thermal spray gun to the surface of the tube; and
means for cooling the tube and the braze alloy layer as the tube travels downstream from the depositing means and before the surface of the braze alloy layer oxidizes.

2. The apparatus according to claim 1, wherein the depositing means comprises at least two thermal spray guns, the two thermal spray guns depositing layers of the braze alloy on opposite surfaces of the tube.

3. The apparatus according to claim 1, wherein the braze alloy consists essentially of copper, tin, phosphorous, and at least 1 weight percent nickel.

4. The apparatus according to claim 1, wherein the at least one thermal spray gun is an arc spray gun, and the metallic material is at least one wire.

5. The apparatus according to claim 4, further comprising means for delivering the inert gas to the arc spray gun as a carrier gas for the metallic material.

6. The apparatus according to claim 4, wherein the braze alloy consists essentially of, by weight, about 6% to about 7% tin, about 1% to about 2.5% nickel, and about 6% to about 7% phosphorus, with the balance being copper and incidental impurities.

7. The apparatus according to claim 1, wherein the at least one thermal spray gun is a plasma spray gun, and the metallic material is a powder.

8. The apparatus according to claim 7, wherein the braze alloy consists of, by weight, about 74.9% to about 79.4% copper, about 9.0% to about 15.6% tin, about 4.2% to about 5.4% nickel, about 5.3% to about 6.2% phosphorus, and incidental impurities.

9. The apparatus according to claim 1, wherein the metallic material is deposited on the surface of the tube at a rate of at least 150 grams/m².

10. The apparatus according to claim 1, further comprising means for roughening the surface of the tube upstream of the depositing means.
